(19) United States
(12) Patent Application Publication
(10) Pub. No.: US 2011/0252338 A1
(43) Pub. Date: Oct. 13, 2011

(54) INNOVATION PIPELINE

(75) Inventors: Patrick J. ASHER, Boerne, TX (US); Joseph Anderson ALFRED, Somerset, NJ (US); Frank CARIELLO, Red Bank, NJ (US); John Michael DONOVAN, San Antonio, TX (US); Kenneth Alan DUELL, Belle Mead, NJ (US); Sreenivasa Rao GORTI, Austin, TX (US); Adam Heath HERSH, Highland Park, IL (US); Larry B. PEARSON, San Antonio, TX (US); Christopher Walker RICE, Parsippany, NJ (US); Sharon Jauer DURHAM, San Antonio, TX (US); Kelly WILLIAMS, Lawrenceville, GA (US); Steven Neil TISCHER, Atlanta, GA (US); Sanjay MACWAN, Marlboro, NJ (US)

(73) Assignee: AT&T INTELLECTUAL PROPERTY I, L.P., Reno, NV (US)

(21) Appl. No.: 12/757,456

(22) Filed: Apr. 9, 2010

(51) Int. Cl. G06F 3/01; G06F 15/16

(52) U.S. Cl. 715/751

(57) ABSTRACT

Unique content generated by a group of individual users is evaluated. First unique content provided by a first user via a social networking website interface is collected at a tangible host server. Second unique content provided by a second user via the social networking website interface is collected at the tangible host server. User input ratings from individual users of the social networking website interface are collected so as to rate the first unique content and second unique content. In a first evaluation stage, the first unique content and second unique content are evaluated based on user input from individual users of the social networking website interface so as to comparatively rank the first unique content and second unique content.

### BACKGROUND

1. Field of the Disclosure

The present disclosure relates to innovation realization. More particularly, the present disclosure relates to the manner in which ideas are recognized, realized and developed as innovations.

2. Background Information

Entities with interests in developing individuals' ideas into innovations sometimes establish mechanisms by which ideas can be submitted for review. Such entities may provide incentives for individuals to submit ideas for review, and committees may be formed to evaluate submissions. Upon approval, such ideas may be realized and developed as innovations.

### BRIEF DESCRIPTION OF THE DRAWINGS

FIG. 1 shows an exemplary general computer system that includes a set of instructions for an innovation pipeline described herein;

FIG. 2 shows an exemplary distributed innovation pipeline network, according to an aspect of the present disclosure;

FIG. 3 shows an exemplary innovation pipeline process, according to an aspect of the present disclosure;

FIG. 4 shows another exemplary innovation pipeline process, according to an aspect of the present disclosure;

FIG. 5 shows an exemplary user webpage interface for an innovation pipeline, according to an aspect of the present disclosure;

FIG. 6 shows another exemplary user webpage interface for an innovation pipeline, according to an aspect of the present disclosure;

FIG. 7 shows another exemplary user webpage interface for an innovation pipeline, according to an aspect of the present disclosure; and

FIG. 8 shows another exemplary innovation pipeline process, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

According to a non-limiting embodiment of the present application, ideas are submitted for development into innovations by one or more members of an organizational entity. The ideas are submitted in the form of unique content submissions. The unique content submissions may include audio, graphical, video, text and software submissions. The organization entity may be a corporation, an educational institution, a religious organization, a non-profit organization and a partnership. The unique content submissions are submitted via a website interface, such as a social networking website accessible to some or all members of the organizational entity. The website interface solicits content submissions using a question framework. The same question framework is provided to each member submitting a unique content submission. Each submitting member will provide different answers to the questions in the question framework depending on the unique content of the submission. The answers to the questions in the question framework are presented in an organized manner via the website interface.

In one non-limiting embodiment, the website interface includes a social networking component. In this embodiment, unique content submissions are classified, labeled and/or categorized based on a category or subject matter of the corresponding idea or innovation. The submissions may be classified, labeled and/or categorized according to subject matter content by the submitters or by a reviewer at an initial stage of review.

Eligible members of the organizational entity vote on the unique content submissions. Voting methods may include any method of indicating a preference including, but not limited to, straight voting, ranking, and/or allocating a value to the unique content submissions. The voting results for unique content submission are subsequently analyzed to determine which of the unique content submissions are winners and which of the winners match criteria specified by the organizational entity.

Those unique content submissions voted to be winners and matching the criteria set by the organizational entity proceed through stages of an innovation pipeline. The stages include a stage in which a business case is presented to a group acting as investors. The business case is analyzed to reach an initial funding decision. If initial funding is approved, the unique content submission is funded for delivery as a prototype. At later stages of funding approvals, the unique content submission is funded for delivery as a product for limited and then full distribution. The business case may be re-analyzed and revised based on feedback from the group acting as investors, or based on feedback from reviewers in subsequent stages in which funding decisions are made.

At the end of a cyclical funding decision process, the unique content submission is funded for mass production by the organizational entity. The unique content submission may also be rejected outright at any stage of a multi-stage innovation pipeline process. During each cycle of the funding decision process, feedback is optionally obtained and provided to a submitter of the unique content submission, and the business case and/or the unique content submission is optionally revised.

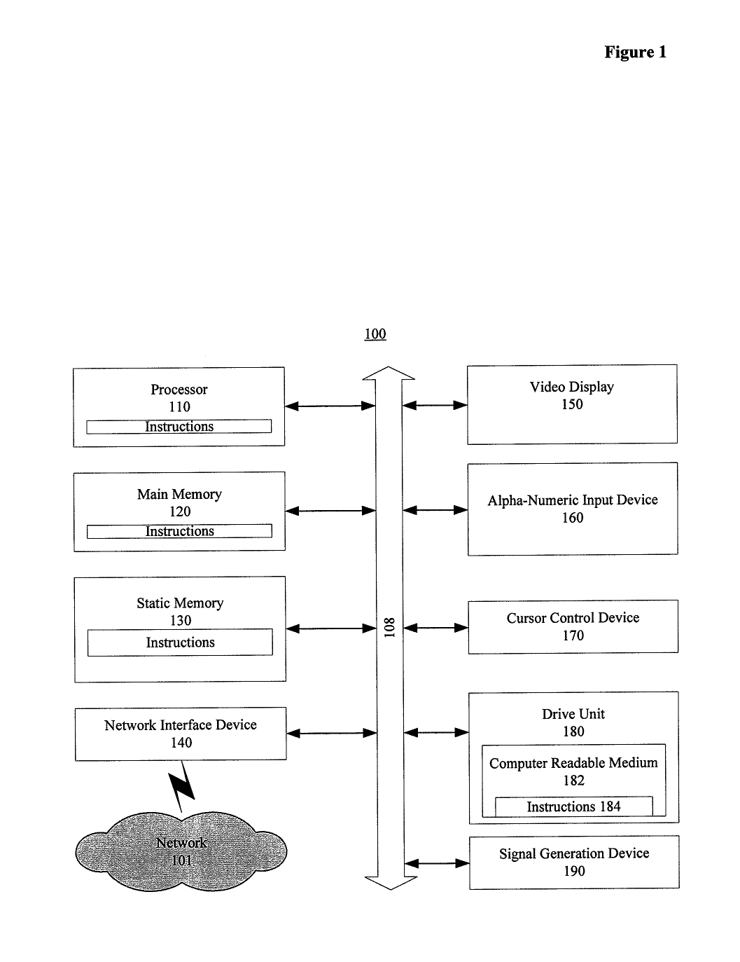

FIG. 1 is an illustrative embodiment of a general computer system that includes a set of instructions for performing processes in an innovation pipeline as described herein. The general computer system is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices. For example, the computer system 100 may include or be included within any one or more of the computers, servers, systems, or communication networks described herein.

In a networked deployment, the computer system may operate in the capacity of a server or as a client user computer in a server-client user network environment, or as a peer computer system in a peer-to-peer (or distributed) network environment. The computer system 100, or portions thereof, can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an alpha-numeric input device 160, such as a keyboard, another input device (not shown), such as a remote control device having a wireless keypad, a keyboard, a microphone coupled to a speech recognition engine, a camera such as a video camera or still camera, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

According to the present disclosure, ideas are submitted for review, and a multi-stage collaborative feedback and approval process is used to enhance the ideas, where applicable. Upon approval, the original or enhanced ideas are moved through to implementation as innovations. In an initial stage where ideas are presented to multiple users via a social networking website, the multiple reviewers who are able to provide feedback are analogous to a crowd of individuals. Feedback and approval or disapproval results from the crowd may be used to determine which ideas are moved along and developed as innovations in the innovation pipeline. Additionally, reviewers are able to build on ideas of others, such that improved ideas can be submitted for consideration in the innovation pipeline. Thus, ideas are subject to crowd refinement and validation. Success using such a system may be determined in multiple ways, including ultimate implementation of ideas as innovations in limited or mass markets.

The feedback and approval process may be used in each of numerous stages of a multi-stage pipeline process. Individuals, subgroups or the entire group of reviewers in a stage may be empowered to approve an innovation to proceed further in the multi-stage pipeline process. In one embodiment, parallel departments in an organization may each be empowered to approve an innovation for advancement between stages. Therefore, an innovation can advance in the innovation pipeline even when one or more of the parallel departments do not approve of the advance, so long as one or more of the parallel departments do approve of the advance.

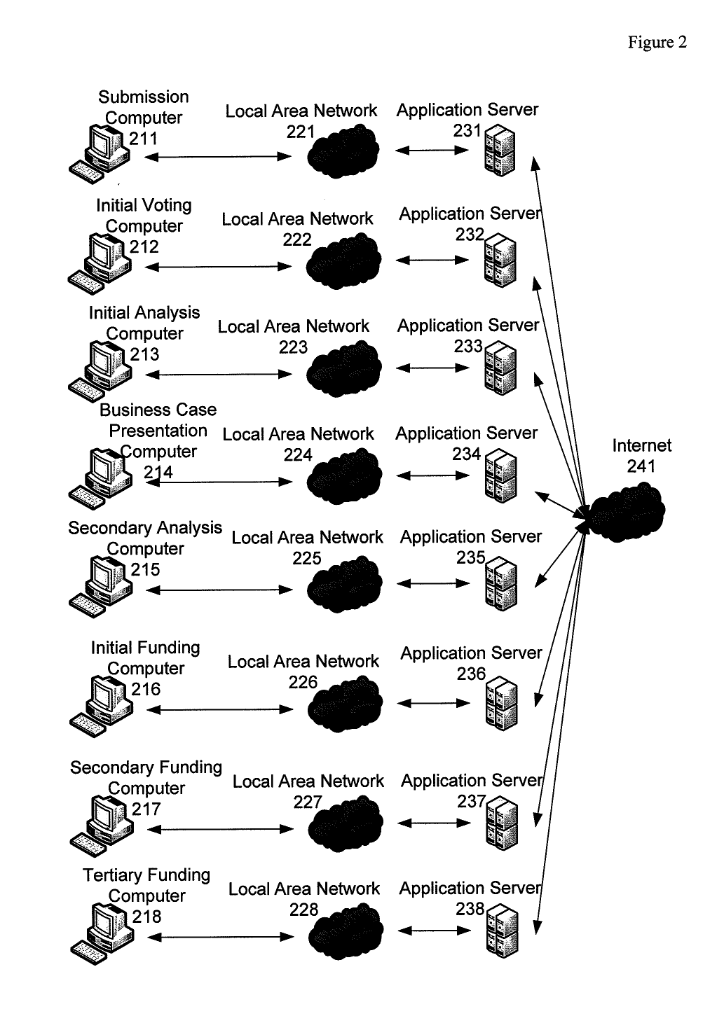

FIG. 2 shows an exemplary distributed innovation pipeline network, according to an aspect of the present disclosure. A submission computer 211 communicates with an application server 231 across a local area network 221. An initial voting computer communicates with an application server 232 across a local area network 222. An initial analysis computer 213 communicates with an application server 233 across a local area network 223. A business case presentation computer 214 communicates with an application server 234 across a local area network 224. Secondary analysis computer 215 communicates with an application server 235 across a local area network 225. Initial funding computer 216 communicates with an application server 236 across a local area network 226. Secondary funding computer 217 communicates with an application server 237 across a local area network 227. Tertiary funding computer 218 communicates with an application server 238 across a local area network 228. Each of application servers 231, 232, 233, 234, 235, 236, 237 and 238 communicates across the internet 241. Although the various computers 211-218 are shown as separate computers, some or all of the features of two or more of these computers as described herein may be performed by a single computer. Similarly, although the various application servers 231-238 are shown as separate application servers, some or all of the features of two or more of these application servers 231-238 may be performed by a single application server.

The submission computer 211 is used by an individual to submit an idea as a unique submission for consideration. The individual submitter may be an employee submitting an idea for consideration to an employer. Alternatively, the individual submitter may be submitting an idea for consideration as a member of a social, educational or familial group. The individual submitter may also be submitting the idea as a third-party submission to an entity with which the individual submitter does not have a formal relationship, such as an entity that solicits third-party submissions as part of a contest. The idea is the individual submitter's unique idea for submission, though the idea may be the creation of another individual or group for whom the individual submitter is acting as a proxy. The idea may be submitted for consideration in response to an incentive such as social recognition and/or the possibility of earning a financial award.

The submission computer 211 is shown in FIG. 2 as communicating with application server 231 across local area network 221. The local area network 221 may be a local wired network, a local wireless network, or any combination of local wired and wireless networks. The application server 231 provides an application by which the individual submitter can submit the idea for consideration. The application provided by the application server 231 may provide a standardized webpage interface of one or more interactive webpages for individual submitters to submit ideas for consideration.

The initial voting computer 212 is used by an individual to vote on ideas submitted as unique submissions for consideration. The individual voter may be a coworker of the individual submitter. Alternatively, the individual voter may belong to a social, educational or familial group along with the individual submitter. The individual voter may also vote on behalf of an entity with which the individual submitter does not have a formal relationship, such as an entity that solicits votes from customers as part of a contest. The vote may be in the form of a simple up/down vote, or may be a ranking of submissions by a voter, or may be an allocation of a voter's available points or indicias of value in an social network voting system. The individual voter may vote on individual submissions as a member of a social network, and the voter may be provided incentives for voting activities.

The initial voting computer 212 is shown in FIG. 2 as communicating with application server 232 across local area network 222. The local area network 222 may be a local wired network, a local wireless network, or any combination of local wired and wireless networks. The application server 232 provides an application by which the individual voter can vote on ideas submitted for consideration. The application provided by the application server 232 may provide a standardized webpage interface of one or more interactive webpages for individual voters to vote on ideas submitted for consideration.

The initial analysis computer 213 is used to analyze votes on ideas submitted as unique submissions for consideration. The analysis may include counting votes and ranking unique submissions according to vote totals. Alternatively, the analysis may include segregating unique submissions based on date and/or time of entry, based on labels for content of the unique submissions, or based on details of the individual submitter for each unique submission. For example, prior to counting votes and ranking unique submissions, a number of unique submissions may be segregated from one another by time periods in which the unique submissions were submitted, so that votes for unique submissions are counted only for unique submissions submitted within one or more specified time periods. A number of unique submissions may be labeled based on the content of each unique submission, and the number of unique submissions may be segregated from one another by the labels for the content, so that votes for unique submissions are counted only for unique submissions with the same or similar labels. A number of unique submissions may be segregated from one another by the workgroup or job titles of the individual submitters, so that votes for unique submissions are counted only for unique submissions within the same or similar workgroup or with the same or similar job titles.

The initial analysis computer 213 is shown in FIG. 2 as communicating with application server 233 across local area network 223. The local area network 223 may be a local wired network, a local wireless network, or any combination of local wired and wireless networks. The application server 233 provides an application by which the votes for unique submissions can be analyzed. The application provided by the application server 233 may provide a standardized webpage interface of one or more interactive webpages for analysis of individual voters on ideas submitted for consideration.

The business case presentation computer 214 is used by an individual to prepare and present a business case on an innovation selected as a winner in the analysis by the initial analysis computer 213. The business case is a report projecting the viability, risks and rewards of implementing the innovation selected as a winner. Considerations that are or can be taken into account in a business case include cost, benefit, market size, profit, revenue, time to market, known competition, or other business and economic considerations that would be useful to consider when determining whether to allocate resources to developing innovations based on an idea. The business case may be prepared and presented by the individual who submitted the selected innovation, and/or by advocates and/or consultants assigned to assist the individual. In this manner, a business entity may provide assistance for employees in having their innovative submissions prepared and presented as a business case once their submissions are selected as winners in the analysis by the initial analysis computer 213. The business case itself may be presented as a full write-up for consideration by managers and/or executives, or may be a summary write-up to support a presentation to a panel or committee of managers or others empowered with decision-making authority. Those who are presented with an initial or revised business case or initial or subsequent funding requests may accept or reject proposals, accept proposals with comments and feedback, or reject proposals with comments and feedback.

The business case presentation computer 214 is shown in FIG. 2 as communicating with application server 234 across local area network 224. The local area network 224 may be a local wired network, a local wireless network, or any combination of local wired and wireless networks. The application server 234 provides an application by which the business case can be prepared and presented for innovations selected as winners. The application provided by the application server 234 may provide a standardized webpage interface of one or more interactive webpages for individuals, advocates and consultants to prepare and present the business case for an innovation submitted for consideration.

The secondary analysis computer 215 is used by an individual to analyze the business case prepared using the business case presentation computer 214. The secondary analysis computer 215 may be used by one or more supervisors or managers to evaluate whether the business case for the innovation warrants proceeding further in the innovation pipeline described herein. The secondary analysis computer 215 may determine a projected profit or profit margin for an innovation, and weigh the projected profit or profit margin for the innovation against profits or profit margins determined for other innovations for which business cases have been presented. Other criteria may be used to analyze a business case for an innovation, including necessary resources, availability of necessary resources, market size, market scale and scope, risks that the projected profit or profit margin will not be obtained, and any other criteria deemed suitable for determining whether to approve a business case for proceeding further in the innovation pipeline. Business opportunities may be evaluated using strength, weakness, opportunities, threats (SWOT) analysis. Evaluations may take into consideration risk factors such as technology risk, including an evaluation of whether a technology can be effectively implemented. An evaluation may also consider whether an idea fits one or more investment theses. Evaluations may also be performed by an automated system and software.

The secondary analysis computer 215 is shown in FIG. 2 as communicating with application server 235 across local area network 225. The local area network 225 may be a local wired network, a local wireless network, or any combination of local wired and wireless networks. The application server 235 provides an application by which a supervisor or manager can analyze a business case submitted for consideration. The application provided by the application server 235 may provide a standardized webpage interface of one or more interactive webpages for a supervisor or manager to analyze a business case submitted for consideration.

A practical result of obtaining approval for proceeding further in the innovation pipeline in the analysis performed by the secondary analysis computer may be that funding is approved for building a prototype for the innovation. This approval for funding may be provided from a general pool provided by a corporate entity, and the prototype may be a software prototype for a service innovation provided using software, or a tangible physical prototype for a device innovation provided using an article of manufacture. Prototypes can be lower fidelity and may include mockups, wireframes, storyboards, computer animations, movies, images, 3-dimensional renderings of wireframe designs and other non-functional representations of a product or service. A goal of prototyping can be to create something that is representative enough or real enough to effectively explore the product concept enabling the assessment of market adoption.

The initial funding computer 216 is used to analyze the prototype for the innovation, and determine whether to fund an initial product roll-out for the innovation. As an example, an entity that provides the innovation pipeline for employees may have several different funding sources in different divisions of the entity. Similar to a venture capital model, investors in control of the different funding sources may review the business case and prototype for the innovation, and determine whether to provide initial product roll-out funding. In this embodiment, this funding is analogous to so-called “Series A” venture capital funding. Alternatively, this funding may be provided from general pools, and is defined only as the funding for an initial product roll-out for the innovation in comparison to later funding for subsequent development.

The initial funding computer 216 is shown in FIG. 2 as communicating with application server 236 across local area network 226. The local area network 226 may be a local wired network, a local wireless network, or any combination of local wired and wireless networks. The application server 236 provides an application by which one or more persons responsible for funding decisions can review business cases and prototypes to determine whether to provide initial funding for ideas submitted for consideration. The application provided by the application server 236 may provide a standardized webpage interface of one or more interactive webpages for individuals responsible for initial funding decisions.

The secondary funding computer 217 is used to analyze the results of an initial roll-out of the product for the innovation, and determine whether to fund a secondary product roll-out sufficient to achieve revenue for the innovation. As noted in an example above, an entity that provides the innovation pipeline for employees may have several different funding sources in different divisions of the entity. Similar to a venture capital model, investors in control of the different funding sources may review the results of the initial roll-out of the product for the innovation, and determine whether to provide secondary product roll-out funding sufficient to achieve revenue for the innovation. In this embodiment, this funding is analogous to so-called “Series B” venture capital funding. This funding may be provided to roll-out the product in a test market, such as a limited geographic market in an overall national market. Alternatively, this funding may also be provided from general pools, and be defined only as the funding for an secondary product roll-out sufficient to achieve revenue for the innovation in comparison to earlier or later funding stages.

The secondary funding computer 217 is shown in FIG. 2 as communicating with application server 237 across local area network 227. The local area network 227 may be a local wired network, a local wireless network, or any combination of local wired and wireless networks. The application server 237 provides an application by which one or more persons responsible for secondary funding decisions can review results of initial product roll-outs to determine whether to provide secondary funding for ideas submitted for consideration. The application provided by the application server 237 may provide a standardized webpage interface of one or more interactive webpages for individuals responsible for secondary funding decisions.

The tertiary funding computer 218 is used to analyze the results of the secondary roll-out of a product for the innovation, and determine whether to fund a full roll-out of production for the innovation. In an example, the analysis by the tertiary funding computer 218 may be a comparison of revenues obtained during secondary roll-out with projections in the earlier business case, to determine if the revenues meet or exceed projections. If the analysis of the secondary roll-out determines that the secondary roll-out was successful, the tertiary funding computer 218 may be used to determine whether to provide product roll-out funding for full development in the mass market. In this embodiment, this funding is analogous to so-called “Series C” venture capital funding.

The tertiary funding computer 218 is shown in FIG. 2 as communicating with application server 238 across local area network 228. The local area network 228 may be a local wired network, a local wireless network, or any combination of local wired and wireless networks. The application server 238 provides an application by which one or more persons responsible for funding decisions can review results of secondary roll-out, as well as business cases and prototypes to determine whether to provide tertiary mass market roll-out funding for ideas submitted for consideration. The application provided by the application server 238 may provide a standardized webpage interface of one or more interactive webpages for individuals responsible for tertiary funding decisions.

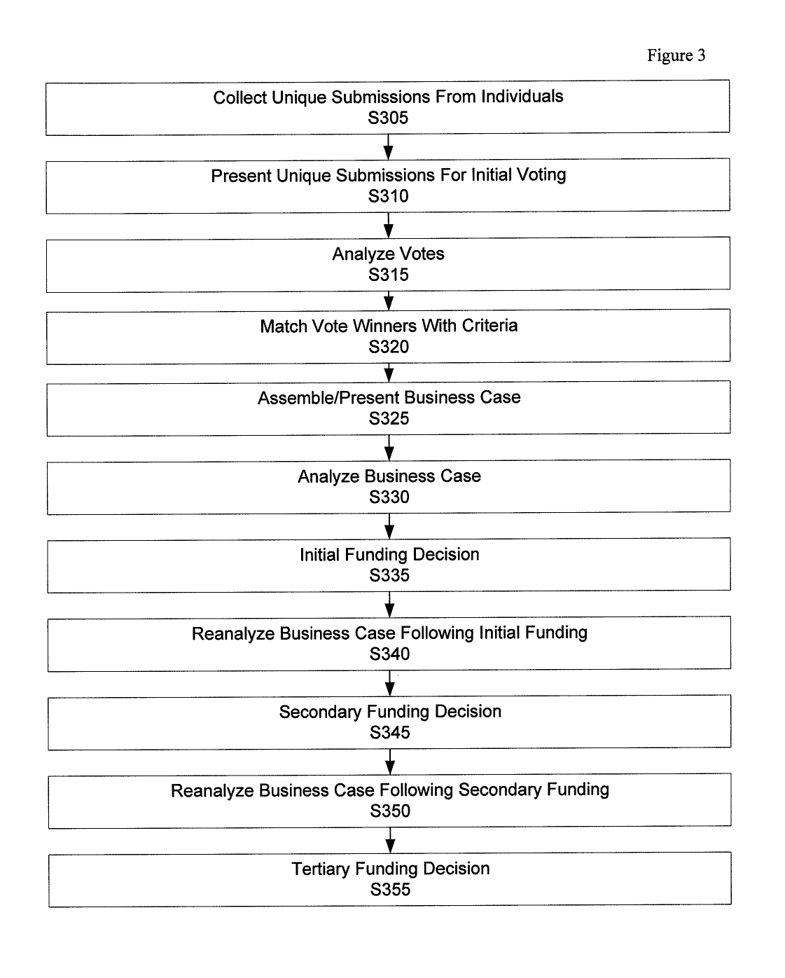

FIG. 3 shows an overview of an exemplary innovation pipeline process, according to an aspect of the present disclosure. At S305, unique submissions are collected from individuals. The individuals may submit unique submissions using a submission computer 211 in FIG. 3, and the unique submissions may be collected at a application server 231 in FIG. 3. In an embodiment, the unique submissions are innovations, and they are collected via a social networking website. Examples of the unique submissions include suggestions for products or services to offer to customers, or innovative ideas for improvement of internal operations, or inventive ideas that meet the standards of patentability set forth in 35 U.S.C. §101, 35 U.S.C. §102 and 35 U.S.C. §103.

At S310, the collected unique submissions are presented for initial voting. The unique submissions may be presented for initial voting by an initial voting computer 212 shown in FIG. 2, and the votes may be collected by an application server 232 shown in FIG. 2. In an embodiment, the collected unique submissions are organized and then presented via a social network website. The unique submissions may be labeled, either automatically based on characters of the submitter or the submissions, or by the submitters upon submission and/or by an administrator after collection. The unique submissions are then presented via a social network website for initial voting. The voting may be a straight approve/disapprove or like/dislike vote. Alternatively, the voting may be based on allocations of value by voters, similar to the manner in which money is used to bid in an auction, such that a voter with more value to allocate has more potential importance in a voting process. Additionally, the entire membership of the social network may be eligible to vote, or a subgroup of the membership may be made eligible. For example, a business entity may limit voting for some innovations to employees in the same or a similar department as the submitter, or employees with the same or similar departments as the submitter. Voting may also be limited to employees above or below a specified rank, or within a specified range of relative ranks in an organization.

At S315, votes for submissions are analyzed. The votes may be analyzed at or by an initial analysis computer 213 shown in FIG. 2 using an application provided by application server 233 shown in FIG. 2. The analysis of votes may include ranking submissions by the raw number of positive votes they received, or the raw weighted total of value where indications of voting value vary per users, or based on differences of positive and negative votes for a submission where applicable. The submissions may be grouped into categories by time or subject or submitter characteristics, before rankings are provided for one or more of the resultant groups.

At S320, vote winners are matched with criteria to see if the vote winners satisfy internal guidelines for advancement in the innovation pipeline. The vote winners are matched with criteria at the initial analysis computer 213 using the application server 233 in FIG. 2. For instance, a popular innovation may not contribute substantially or at all to any recognized interests of the entity that provides the innovation pipeline, so that the entity has little or no interest in developing the innovation. In such an instance, the entity may see if positive feedback from members of the social network was provided for the innovation, and the positive feedback may then be provided to the submitter of the innovation so that the submitter can explore the possibility of revising the innovation and resubmitting the revised innovation. On the other hand, vote winners that also match internal criteria will advance to a stage where a business case for the innovation is assembled and presented.

At S325, the business case is assembled and presented. The business case is built with the business case presentation computer 214 using an application from the application server 234 in FIG. 2. The business case includes a set of arguments and analyses as to the projected possibilities of earning revenues and profits if the innovation is implemented and sold to customers. The business case is built using the best estimates of market size, price potential, costs, necessary materials and manpower, time to market, regulatory environment, and any other factors that might be considered to have a substantial impact on potential revenues and profits if the innovation is implemented.

At S330, the business case is analyzed. The business case is analyzed by the secondary analysis computer 215 using an application from the application server 235 shown in FIG. 2. The analysis of the business case may include a reevaluation of the estimates used in building the business case, the projected possibilities of revenues and profits, and a comparison of the business case for an innovation with other business cases for other innovations. If the analysis of the business case results in a positive conclusion, funding for a prototype of the innovation is provided and a prototype is built. The prototype may include developing a software program and/or building a physical device, or merely developing a complete algorithm of a service.

At S335, an initial funding decision is made. The initial funding decision may be made using an initial funding computer 216 with an application provided by the application server 236 shown in FIG. 2. The initial funding decision is based on an analysis of the prototype for the innovation, and determines whether to fund an initial product roll-out for the innovation. The initial funding decision may be made based on an evaluation of a prototype developed at 5330, as well as an analysis of the business case and the innovation itself. If initial funding is to be provided for the innovation, innovation is developed as a product, and the product is rolled-out in an initial stage.

The business case is subsequently reanalyzed at S340, following the initial roll-out of the product upon an affirmative initial funding decision at S335. If the initial roll-out is successful, a secondary funding decision is made at S345. The secondary funding decision is made using a secondary funding computer 217 with an application from the application server 237 in FIG. 2. The secondary funding may be provided so as to roll-out a produced in a limited market and obtain revenues and customer feedback. The business case is again reanalyzed at S350, taking into consideration the revenue results and customer feedback obtained in the limited market roll-out after the secondary funding.

At S355, a tertiary funding decision is made. The tertiary funding decision may be made using a tertiary funding computer 218 with an application provided by application server 238 in FIG. 2. The tertiary funding decision is a decision whether to roll the innovation out as a product to the mass market, or at least a market wider or otherwise different than the market in which the product was sold following the secondary funding decision at 5345.

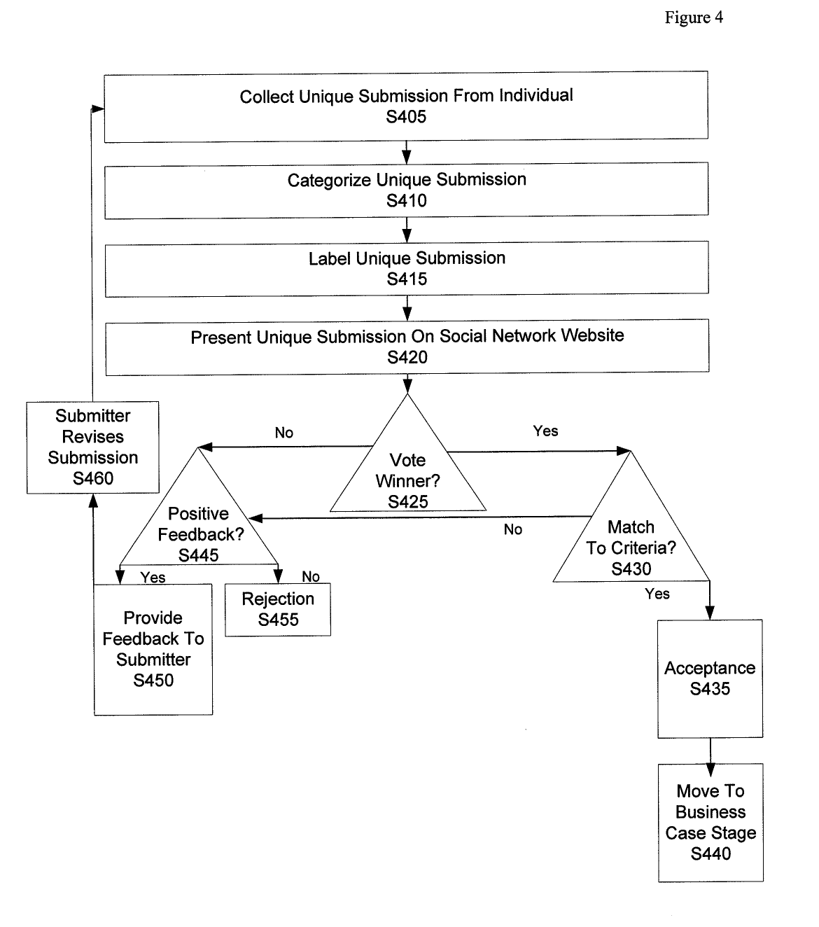

FIG. 4 shows another exemplary innovation pipeline process, according to an aspect of the present disclosure. The embodiment of FIG. 4 shows details of an exemplary process from the submission stage to the business case stage. At S405, a unique innovation is submitted by an individual and collected from the individual. The unique submission may be received via an application server from an individual visiting a social network website. The social network website solicits innovations from individuals affiliated with an entity. For example, the social network website may be provided by an employer, a social group, a family group, a governmental group, an educational institution, or any other entity that may have an interest in collecting innovative submissions from affiliated individuals. At S410 the submission is categorized, and at S415 the submission is labeled. Alternatively to this embodiment, the submission may be labeled before being categorized. The submission may be labeled by the submitter or by an initial reviewer responsible for labeling and categorizing submissions.

At S420, the unique submission is presented on a social network website. The unique submission may be presented as one of many submissions, either in order of receipt, or based on the labeling and categorization at S410 and S415. At S425 the vote winner is determined. If the submission under consideration is not a vote winner (S425=No), a determination is made at S445 as to whether positive feedback was received via the social networking website for the submission. If positive feedback was not received (S445=No), the process ends with the submission being rejected at S455. The submitter of the innovation may thereafter be advised that the submission will not proceed further in the innovation pipeline. If positive feedback was received via the social network (S445=Yes), the positive feedback may be provided to the submitter at S450, and the submitter is given the opportunity to revise the submission at S460. A revised submission is subject to the entirety of the process in FIG. 4 again, beginning with the collection of the unique (revised) submission from the individual at S405.

If the submission is a vote winner (S425=Yes), a determination is made at S430 as to whether the submission matches internal criteria of the entity. If the submission does not meet internal criteria of the entity (S430=No), the determination is made as to whether positive feedback is received for the submission at S445, and the submission is subject to the processes described with respect to S445, S450, S455 and S460 above. If the submission meets internal criteria of the entity (S430=Yes), the submission is accepted at S435 and the submission proceeds to the business case stage at S440.

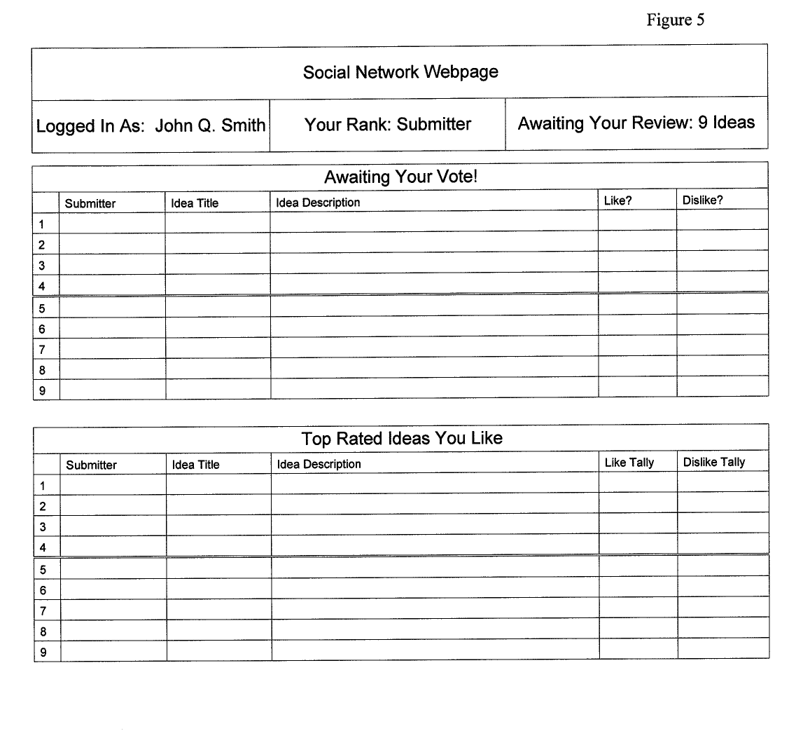

FIG. 5 shows an exemplary user webpage interface for an innovation pipeline, according to an aspect of the present disclosure. In the exemplary user webpage interface of FIG. 5, an individual visitor logged in as John Q. Smith is ranked as a submitter and presented a list of innovations awaiting his personalized review and vote. The innovations are listed with submitter, title and description, and John is given the opportunity to indicate whether he specifically likes or dislikes each innovation.

In the exemplary user webpage interface of FIG. 5, John is also presented with a list of the top rated submissions which he has previously indicated he likes. Even if John has previously reviewed and indicated that he likes hundreds of innovations, the innovation pipeline will provide feedback to John as to which of these ideas are the highest rated in the innovation pipeline system. The list of popular ideas in FIG. 5 may be limited to ideas with similar labels or in similar categories, or to recently submitted ideas, or ideas submitted by workers with the same or similar job titles or assigned to the same or similar workgroups. The determination as to which ideas are top rated may also be based upon a raw number of positive votes, a differential between positive and negative votes, or any other measure by which ideas may be rated and ranked.

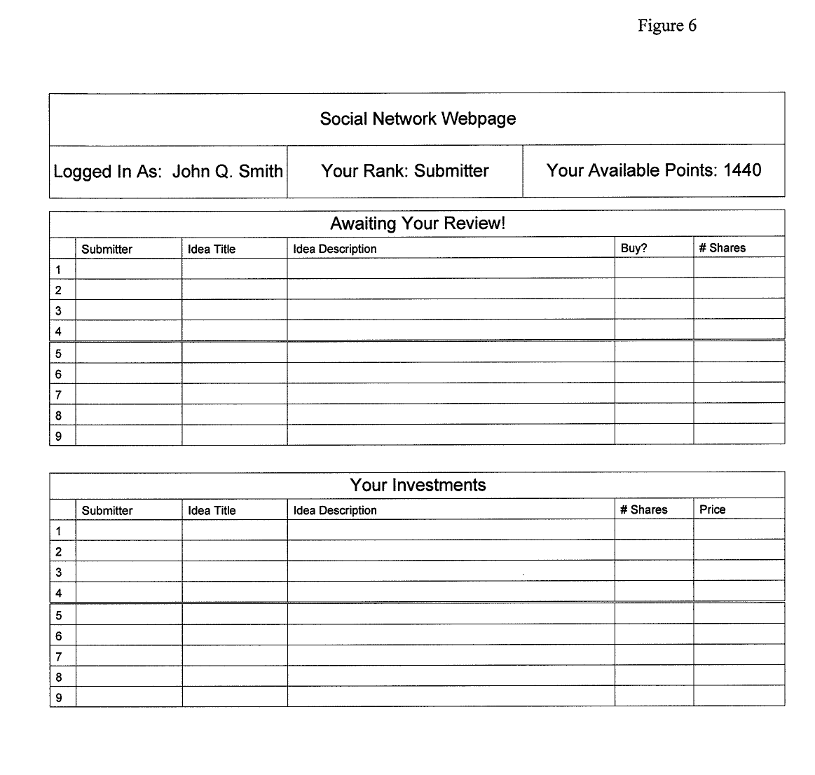

FIG. 6 shows another exemplary user webpage interface for an innovation pipeline, according to an aspect of the present disclosure. In the exemplary user webpage interface of FIG. 6, the individual visitor logged in as John Q. Smith is again ranked as a submitter, and is again presented a list of ideas awaiting his personalized review and vote. The ideas are listed with information of the submitter, the title and a substantive description. However, in the embodiment of FIG. 6, John is given points to allocate in voting for submissions. John can allocate these points to submissions so as to invest in submissions with these points, similar to the manner in which investors invest in shares of stock in the stock market. John can specify the number of shares of an idea to buy. Though not shown, the webpage of FIG. 6 may also give John a price of each share for an idea in the case that share prices differ for different ideas. Therefore, rather than being an opportunity to provide only a simple like or dislike vote, the embodiment of FIG. 6 gives John an ability to invest a relative indicia of value in a submission by buying shares in the submission to indicate relative approval given the relative allocable wealth provided to John as a voter.

In the exemplary user webpage interface of FIG. 6, John is also presented with a list of his investments, including his previous allocations of shares in each listed submission and the current price of each submission. Even if John has previously reviewed and invested in hundreds of ideas, the innovation pipeline will provide feedback to John as to which of these ideas are the highest valued in the innovation pipeline system. In the same manner of the embodiment of FIG. 5, the list of popular ideas may be limited in any manner, including ideas with similar labels or in similar categories, or ideas submitted by workers with the same or similar job titles or assigned to the same or similar workgroups. The determination as to which ideas are top rated may also be based upon a raw price of shares, or a market capitalization based on the number of outstanding shares and the relative price, or any other measure by which ideas may be rated and ranked.

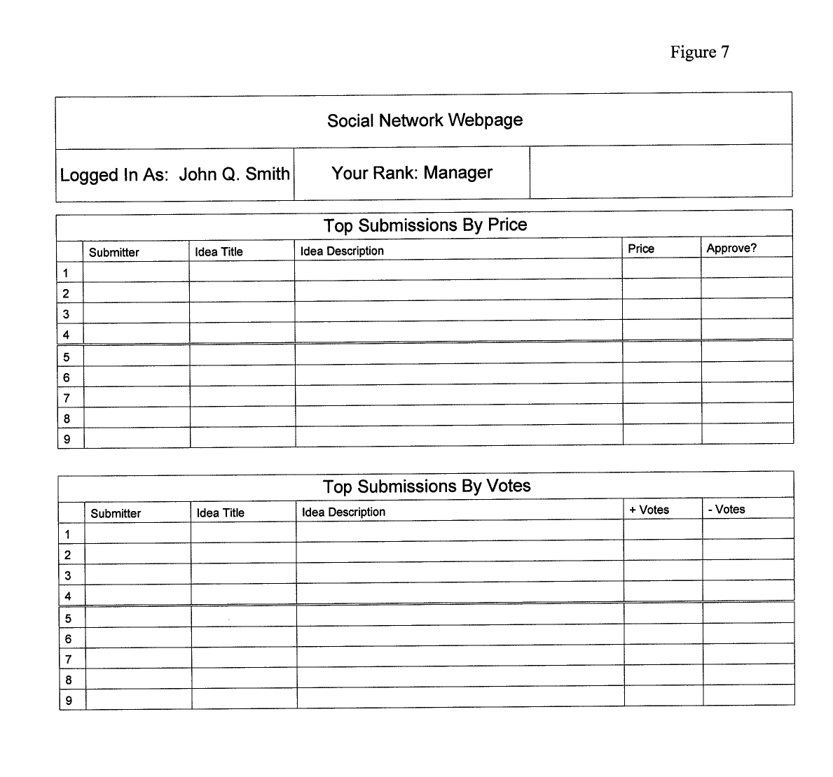

FIG. 7 shows another exemplary user webpage interface for an innovation pipeline, according to an aspect of the present disclosure. In FIG. 7, John is given a rank of Manager, and a role of reviewing top submissions. In the embodiment of FIG. 7, John may be the manager using the initial analysis computer 213 with an application from the application server 233 in FIG. 2. In FIG. 2, John is given two views of top submissions by price and top submissions by positive and negative votes. In this example, voters may be given opportunities to provide a simple like/dislike vote, or a weighted vote by allocating indicias of value to submissions so as to buy into the submissions. John reviews the top submissions by price and votes, and determines whether the winners match criteria of the entity, as in S325 of FIG. 3, such that a business case can be assembled for each submission.

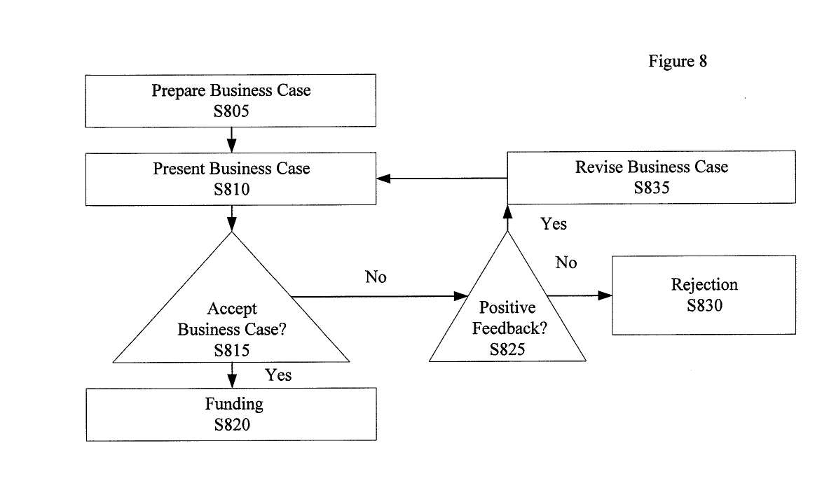

FIG. 8 shows another exemplary innovation pipeline process, according to an aspect of the present disclosure. In the embodiment of FIG. 8, a business case is prepared at S805. The business case is presented at S810. At S815, a determination is made as to whether the business case should be accepted. If the business case is accepted (S815=Yes), the funding process begins at S820. The funding process beginning at 5820 in FIG. 8 may correspond to the funding processes at S335, S340, S345, S350 and S355 in the embodiment of FIG. 3.

If the business case is not accepted at S815 (S815=No), a determination is made at S825 as to whether positive feedback is received at S825. If positive feedback has not been received (S825=No) for a submission for which a business case is not accepted (S85=No), the submission is rejected at S830 and the submitter is informed. If positive feedback has been received for a submission (S825=Yes), the submitter is given the opportunity to revise the business case at S835, in which case the revised business case is resubmitted and presented at S810.

Although not shown in FIG. 8, alternatives to any level or stage of funding in the embodiments described herein include spinning off or otherwise disposing of an idea or resultant innovations to an outside party by sale, lease or analogous transactions. Similarly, an entity may form a business unit around innovations resultant from an idea, even before the innovations reach the tertiary funding stage. Thus, if an idea and resultant innovation is recognized early in the process as presenting a potentially lucrative opportunity, an entity may form a business unit and assign resources to press the idea and resultant innovations through the pipeline to the final funding stages.

Accordingly, the present disclosure enables an entity to provide an innovation pipeline in which individuals can submit ideas in a manner that such ideas are judged and approved in a multi-stage process. Ideas may progress through the pipeline until implementation as an innovation such as a product offering. Alternatively, ideas may progress until being modified as the result of feedback obtained during the multi-stage process. Success may be defined in many ways using such a multi-stage process, so that the organizational entity benefits from the submission of ideas that are developed into full scale market roll-outs as well as ideas that are developed into innovations used internally.

In an embodiment, even if funding is denied by multiple managers/executives or committees with authority to provide funding at a stage, an innovation can proceed through the innovation pipeline described herein so long one or more other empowered managers/executives or committees is willing to provide funding for advancement at this stage. In another embodiment, multiple funding sources are each required to agree to provide funds before an innovation can proceed through the innovation pipeline. Ideas and resultant innovations may be placed in front of multiple persons in the entity such that the value of an idea or resultant innovation may be recognized by the approval of a crowd of equals or by one or more individuals in positions of authority.

According to an exemplary embodiment of the present application, a number of employees at an organizational entity each generate ideas. The employees submit these ideas as unique content submissions to be reviewed by other employees in the organizational entity using a website interface. In the exemplary embodiment, a question framework is used to describe and categorize the employees' unique content submissions. More particularly, questions in the question framework may include the following questions: (1) “What business unit did this idea originate from”; (2) “What technology area does this idea relate to?”; (3) “Is this idea an improvement on an existing business product or an entirely new idea?”; (4) “Does this idea work in coordination with another product or idea?”; (5) “Who contributed to this idea?”; and (6) “How would you formulate a prototype of this idea?”. As will be understood by one of ordinary skill in the art, the above-noted questions are merely representative and are not intended to limit the scope of the present application.

As an example, the unique content submission may be an idea for a chat client installable on disparate mobile devices. The mobile chat client unique content submission is presented on the website interface which, in one embodiment, is a social networking website. The mobile chat client submission is subsequently subjected to a voting process. In one embodiment, each of the employees of the corporation, regardless of position in a corporate hierarchy (e.g., project manager, program manager, business unit managers and division managers), are permitted to vote on unique content submissions. In another exemplary embodiment, only division managers or analogous supervisors in a hierarchy are permitted to participate in the voting process. The division managers vote on unique content submissions submitted by the employees of the organizational entity.

As will be understood by one of ordinary skill in the art, any full set or subset of the employees of the corporation are permitted to participate in the voting process. In one embodiment, rules are defined to indicate which subset of the employees may participate in the voting process. For example, a rule may be defined to exclude any employee that reviews or supervises the submitter's work from the voting process. In the foregoing example, the division manager for the submitter of the mobile chat client submission is not permitted to the vote on the mobile chat client submission.

In an exemplary embodiment, the division managers vote by purchasing “stock” in a unique content submission. The amount of stock purchased with respect to a particular content submission determines a relative stock price for the unique content submission. In this example, the division managers are given a finite amount of “points” with which to purchase stock in the mobile chat client submission. As another example, division managers vote on the mobile chat client submission (along with other unique content submissions) using a straight voting process; that is, division managers either vote to “approve” or “disapprove” the mobile chat client submission. As yet another example, division managers vote on the mobile chat client submission by ranking the submission with respect to other chat client submissions. Those unique content submissions with the highest stock prices, the greatest number of votes or the highest rank are considered to be vote “winners”. As will be understood by one of ordinary skill in the art, the foregoing is not intended to limit scope of the present application to any particular one or particular subset of voting methods.

Vote winners are matched to criteria specified by the organizational entity. That is, the vote winners are analyzed to determine which of the corresponding unique content submissions meet business goals and/or business initiatives set forth by the organizational entity. For example, if business goals include developing inexpensive communications software and business initiatives include increasing short-term software projects internal to the company, then the mobile chat client submission will be considered to match the criteria. If business goals only included developing semiconductor processing software, then even though the mobile chat client submission was considered a vote winner, the unique content submission will be rejected because it does not meet the business goals and initiatives set forth by the organizational entity.

After the mobile chat client submission is determined to meet the criteria specified by the organizational entity, the submitter assembles and presents a business case that specifies best estimates of market size, price potential, costs, necessary materials and manpower, time to market, regulatory environment, and any other factors that might be considered to have a substantial impact on a funding decision, and potential revenues, profits if the resultant innovation is implemented.

The business case is analyzed and an initial funding decision is made by a group of decision-makers. The initial funding decision includes an acceptance, an acceptance with comments, a rejection with comments and a rejection. In the exemplary embodiment, the initial funding decision is an acceptance with comments. The business case is revised based on the comments from the decision-makers. For example, the decision-makers may decide that there is not enough information on a timetable to produce mobile chat client software. Accordingly, this information is provided to the submitter in the form of comments so that the business case is revised accordingly.

When the analysis of the business case results in a positive conclusion, funding for a prototype of the innovation is provided and a prototype is built. If the decision-makers agree to provide initial funding for the innovation described in the business case, the mobile chat client is developed as a prototype. For example, a beta version of the mobile chat client software is provided to company employees for comments and feedback.

The business case is subsequently re-analyzed and updated following the production of the prototype, as well as after subsequent funding stages. If the mobile chat client prototype is deemed to be successful, the group of investors makes a positive secondary funding decision. In the exemplary embodiment, the mobile chat client receives positive feedback and only minimal comments requiring aesthetic and not functional changes to the software. If the secondary funding decision is positive, the mobile chat client is produced for limited distribution to the public, in order to obtain revenue information and customer feedback.

The business case is analyzed for a third time, taking into account revenue gained and the revenue results and customer feedback obtained producing the mobile chat client. In the exemplary embodiment, the mobile chat client has significant customer commentary, however, also has produced over $2 million in revenue. After the business case is analyzed for the third time, a tertiary funding decision is made. In the exemplary embodiment, even though the mobile chat client has produced sufficient revenue, the customer comments require a significant software change to provide compatibility with all mobile devices. The customer comments also indicate the presence of several other types of mobile chat clients. Therefore, the group of investors decides not to roll the mobile chat client as a product to the mass market.

As described herein, the chance of worthwhile innovations going undeveloped within an organization is reduced, while individuals in the entity are encouraged to submit ideas knowing that ideas can be recognized and rewarded in many ways within the innovation pipeline. For example, an idea may be recognized at any stage as a proper basis for preparing and filing a patent application, whether or not the idea is ultimately developed as a product that proceeds through the entirety of an innovation pipeline. Success may also be achieved when ideas result in innovations that are only developed and applied internally within an organization, such as in instances where the organization sees reductions in costs. Therefore, the multi-stage innovation pipeline described herein both encourages the submission of ideas for implementation as innovations, and obtains successful results in a variety of ways. The multi-stage innovation pipeline described herein also can be used to encourage a collaborative process where ideas and innovations are evaluated for advancement, with or without enhancements based on feedback, at multiple stages and by multiple different individuals and departments in a business entity.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, although the description herein references multiple individual computers, local area networks and application servers, the descriptions herein would be applicable to subsequent or equivalent systems in which multiple or even all applications are provided by one ore more application servers in a cloud environment provided by a third party. Similarly, the descriptions herein would be applicable to subsequent or equivalent systems in which individuals in an entity are distributed worldwide and each of the applications described herein is provided by one or more than one centralized application servers.

According to an aspect of the present disclosure, a method for evaluating unique content generated by a group of individual users includes collecting, at a tangible host server, first unique content provided by a first user via a social networking website interface. The method also includes collecting, at the tangible host server, second unique content provided by a second user via the social networking website interface. User input ratings from individual users of the social networking website interface are accepted so as to rate the first unique content and second unique content. In a first evaluation stage, the first unique content and second unique content are evaluated based on user input from individual users of the social networking website interface so as to comparatively rank the first unique content and second unique content.

According to another aspect of the present disclosure, the method includes describing at least one of the first unique content and the second unique content using descriptors from a question framework.

According to yet another aspect of the present disclosure, at least one of the first unique content and the second unique content is categorized for presentation on the social networking website interface.

According to still another aspect of the present disclosure, at least one of the first unique content and the second unique content is labeled for presentation on the social networking website interface.

According to another aspect of the present disclosure, the method includes revising at least one of the first unique content and the second unique content based on comments from the individual users of the social networking website interface.

According to yet another aspect of the present disclosure, feedback is generated based on comments from the individual users of the social networking website interface. At least one of the first unique content and the second unique content is revised based on the feedback.

According to still another aspect of the present disclosure, the user input ratings are based on at least one of: a number of votes, an intensity of activity, and an indicia of valuation.

According to another aspect of the present disclosure, the individual users of the social networking website interface vote for at least one of the first unique content and the second unique content.

According to yet another aspect of the present disclosure, the individual users of the social networking website interface comment on at least one of the first unique content and the second unique content.

According to still another aspect of the present disclosure, the individual users of the social networking website interface buy value in at least one of the first unique content and the second unique content.

According to another aspect of the present disclosure, the individual users of the social networking website interface choose at least one of the first unique content and the second unique content based on a category or a label specifying a type of content.

According to still another aspect of the present disclosure, the individual users of the social networking website interface are incentivized to evaluate at least one of the first unique content and the second unique content.

According to an aspect of the present disclosure, a method for selecting investments includes collecting, at a tangible host server, unique investment proposals provided by users via a social networking website interface. Ratings of the unique investment proposals are accepted from individual users of the social networking website interface so as to rate the unique investment proposals. A subset of the unique investment proposals are selected for funding based at least in part on the ratings from individual users of the social networking website interface. According to another aspect of the present disclosure, the method also includes matching ratings of the unique investment proposals to predetermined criteria.

According to yet another aspect of the present disclosure, the method includes developing an initial business case for each unique investment proposal that meets the predetermined criteria. According to still another aspect of the present disclosure, the method also includes analyzing the initial business case to determine an initial funding decision. According to another aspect of the present disclosure, the method includes re-analyzing a revised version of the initial business case and determining a secondary funding decision. According to yet another aspect of the present disclosure, the revised version of the initial business case is based on at least one of: an acceptance with comments, a rejection, and a rejection with comments. According to still another aspect of the present disclosure, the method includes developing a prototype based on the revised version of the initial business case, and developing a product based on the prototype.

According to another aspect of the present disclosure, a tangible host server for selecting investments includes a receiver that receives unique investment proposals provided by users via a social networking website interface. A processor accepts ratings of the unique investment proposals from individual users of the social networking website interface so as to rate the unique investment proposals. A subset of the unique investment proposals are selected for funding based at least in part on the ratings from individual users of the social networking website interface.

While a computer-readable medium herein may be shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for power over ethernet represent an example of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for evaluating unique content generated by a group of individual users, comprising:
collecting, at a tangible host server, first unique content provided by a first user via a social networking website interface;
collecting, at the tangible host server, second unique content provided by a second user via the social networking website interface;
accepting user input ratings from individual users of the social networking website interface so as to rate the first unique content and second unique content; and
evaluating, in a first evaluation stage, the first unique content and second unique content based on user input from individual users of the social networking website interface so as to comparatively rank the first unique content and second unique content.

2. The method according to claim 1, further comprising:
describing at least one of the first unique content and the second unique content using descriptors from a question framework.

3. The method according to claim 1,
wherein at least one of the first unique content and the second unique content is categorized for presentation on the social networking website interface.

4. The method according to claim 1,
wherein at least one of the first unique content and the second unique content is labeled for presentation on the social networking website interface.

5. The method according to claim 1, further comprising:
revising at least one of the first unique content and the second unique content based on comments from the individual users of the social networking website interface.

6. The method according to claim 1,
wherein feedback is generated based on comments from the individual users of the social networking website interface, and
wherein at least one of the first unique content and the second unique content is revised based on the feedback.

7. The method according to claim 1,
wherein the user input ratings are based on at least one of: a number of votes, an intensity of activity, and an indicia of valuation.

8. The method according to claim 1,
wherein the individual users of the social networking website interface vote for at least one of the first unique content and the second unique content.

9. The method according to claim 1,
wherein the individual users of the social networking website interface comment on at least one of the first unique content and the second unique content.

10. The method according to claim 1,
wherein the individual users of the social networking website interface buy value in at least one of the first unique content and the second unique content.

11. The method according to claim 1,
wherein the individual users of the social networking website interface choose at least one of the first unique content and the second unique content based on a category or a label specifying a type of content.

12. The method according to claim 1,
wherein the individual users of the social networking website interface are incentivized to evaluate at least one of the first unique content and the second unique content.

13. A method for selecting investments, comprising:
collecting, at a tangible host server, unique investment proposals provided by users via a social networking website interface;
accepting ratings of the unique investment proposals from individual users of the social networking website interface so as to rate the unique investment proposals; and
selecting a subset of the unique investment proposals for funding based at least in part on the ratings from individual users of the social networking website interface.

14. The method according to claim 13, further comprising:
matching ratings of the unique investment proposals to predetermined criteria.

15. The method according to claim 14, further comprising:
developing an initial business case for each unique investment proposal that meets the predetermined criteria.

16. The method according to claim 15, further comprising:
analyzing the initial business case to determine an initial funding decision.

17. The method according to claim 16, further comprising:
re-analyzing a revised version of the initial business case and determining a secondary funding decision.

18. The method according to claim 17,
wherein the revised version of the initial business case is based on at least one of: an acceptance with comments, a rejection, and a rejection with comments.

19. The method according to claim 17, further comprising:
developing a prototype based on the revised version of the initial business case; and
developing a product based on the prototype.

20. A tangible host server for selecting investments, comprising:
a receiver that receives unique investment proposals provided by users via a social networking website interface;
a processor that accepts ratings of the unique investment proposals from individual users of the social networking website interface so as to rate the unique investment proposals,
wherein a subset of the unique investment proposals are selected for funding based at least in part on the ratings from individual users of the social networking website interface.
